(19) United States
(12) Patent Application Publication
(10) Pub. No.: US 2002/0126832 A1
(43) Pub. Date: Sep. 12, 2002

(54) System for interfacing a circuit that makes a private payphone sound like a real bell payphone

(76) Inventor: Jeffrey Somma, Chula Vista, CA (US)

Correspondence Address: Jeff Somma, 1064 Paseo Del Norte, Chula Vista, CA, 91910, US

(21) Appl. No.: 09/803,743

(22) Filed: Mar. 9, 2001

(51) Int. Cl. H04M 1/00; H04M 9/00

(52) U.S. Cl. 379/399.01

(57) ABSTRACT

A toll telephone that has a circuit that makes a private payphone, sound like a real Bell Co. payphone. The mic path switches off to a Central Office, and reroutes sound back to your ear piece (receiver) while not enabled by the microprocessor.

### BACKGROUND OF INVENTION

1. Field of the Invention

The present invention relates to the telephony art.

2. Description of the Prior Art

All privately owned pay telephones employing electronic circuitry in use today are designed to have the transmitter (Microphone, i.e. Mic) in a non-operational mode until the phone call is completed. This was done as an anti-fraud measure. If the Mic was turned on at all times, and therefore allowing sound and data to be passed onto a phone line, the user of the phone would be able to send information out on the line without paying for the service. If Dual Tone Multi Frequency (DTMF) tones were to be sent, a central office would consider that as the phone being dialed. Without having dialed the number through the pay phones keypad, no money would be requested or collected. This is why when a person initially picks up the handset, there is no feedback from the phone if sound (such as talking or blowing over the mouthpiece) is created into the phone. Once the call has been dialed, and the user is instructed by the pay phone to deposit the correct amount of money, and the user has, done so, the pay phone will then, and only then, dial out the DTMF tones to cause a central office (C.O.) to route the call. Once a valid connection is made, a C.O. sends an audio signal back to the phone to indicate that the call is complete and a talk path can be opened to allow verbal communication to commence. The major problem with this method is that a faulty transmitter in the handset would not be noticed until the call is considered to have gone through and the pay phone is then set to collect the money.

### SUMMARY OF THE INVENTION

With the Open Mic Circuit described, this problem is avoided. When the phone is initially picked up, sound from the Mic is routed not to a phone line, but rather is combined with the sound from a phone line (i.e. Dial Tone) that the user hears. This way when the user speaks or blows over the mouthpiece, they will hear the sound feed back (known as Side Tone) into the earpiece. The user is not aware that this is a false Side Tone, and is not actually reaching a phone line. When the user hears this Side Tone they are confident that the phone and handset are operational. When the call is made and the connection is made, a signal from the controlling microprocessor is used to switch the audio path from the false Side Tone to the actual line path so that the phone conversation can begin. The values of the interfacing components are selected to make this transaction from the false to real Mic as smooth as possible. That the user would not be able to notice this change, and will believe that the Mic had been open the entire time. This allows the customer owned pay telephone to sound as if it was operating the same as the original Bell owned and operated phone.

### BRIEF DESCRIPTION OF THE DRAWINGS

FIG. 1 is an overall block diagram view of how the Open Mic Circuit operates, to route the sound to either the ear piece of the user or sent out to a phone line.

FIG. 2, illustrates pin connections of a micro-processor circuit and associated electronics used with the toll telephone.

FIG. 3 is a schematic showing how the Mic input is rerouted to a secondary switch path that connects to the audio circuit witch allows you to hear the Mic/fake sound from the handset.

FIG. 4 is a schematic that shows the different paths and how the simulated sound blends into the audio circuit so that the switching process goes undetected.

### DETAILED DESCRIPTION OF A PREFERRED EMBODIMENT

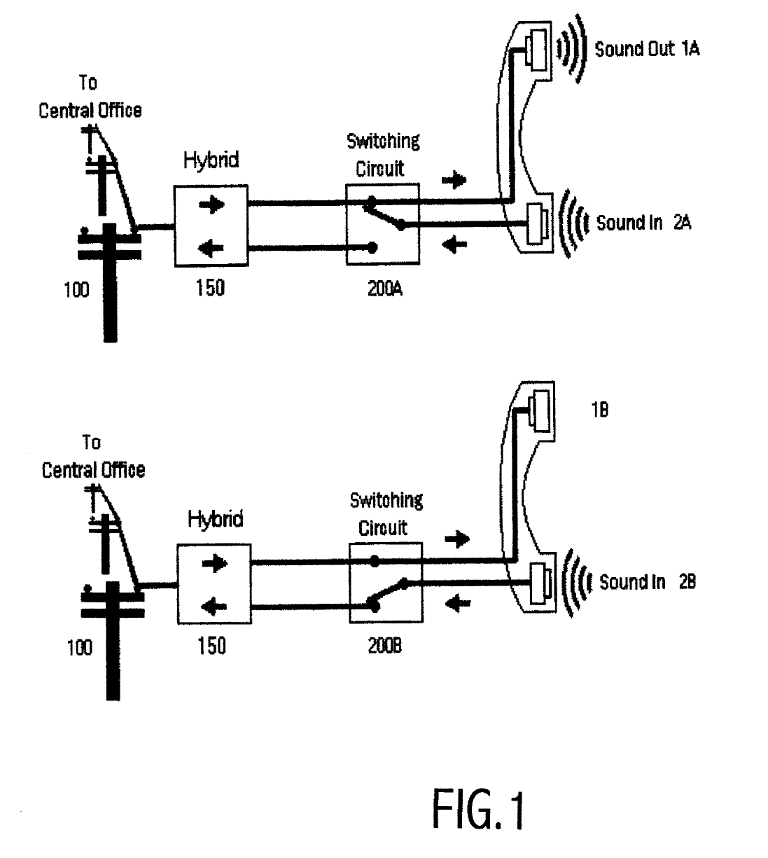

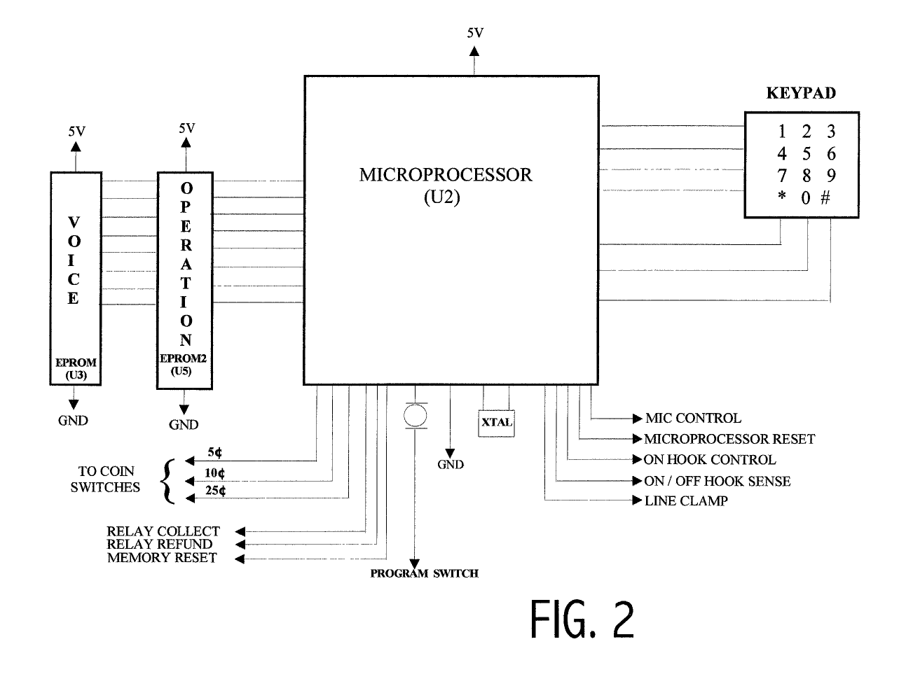

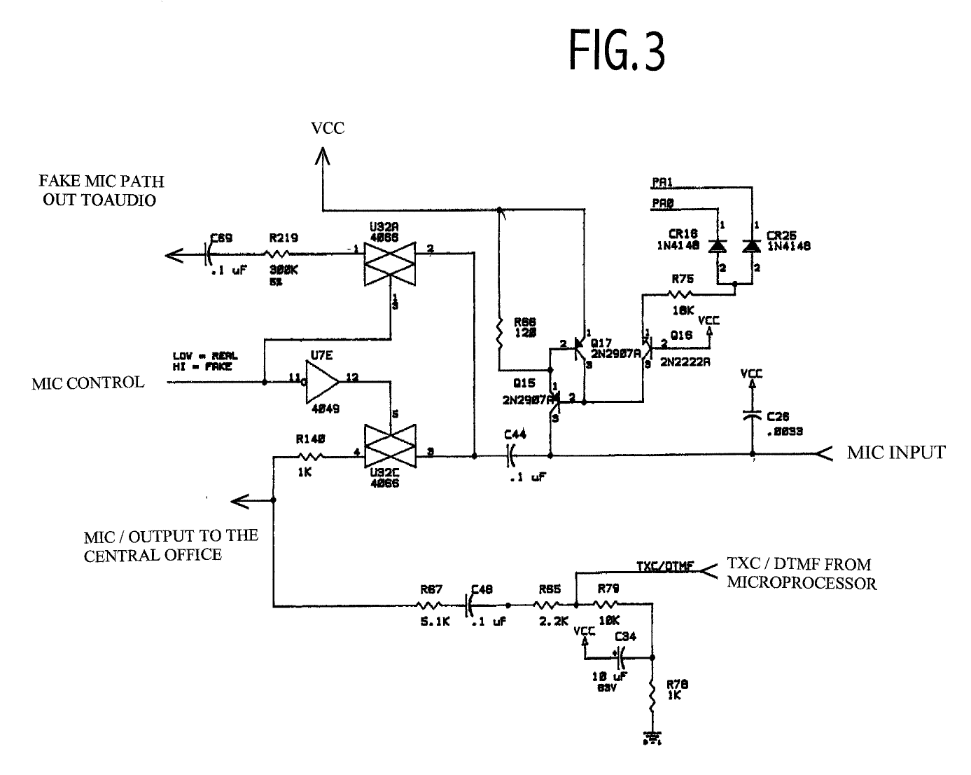

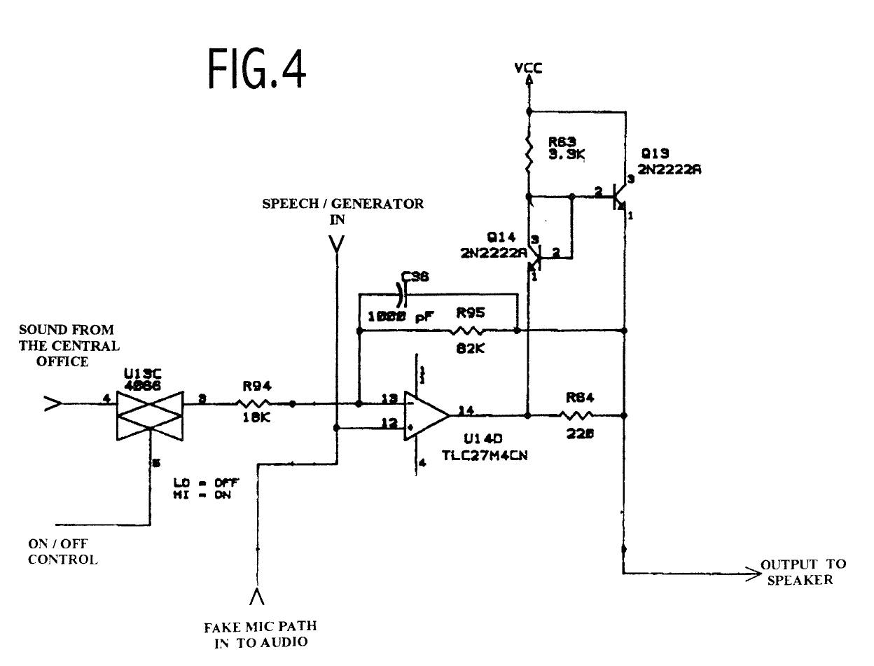

A preferred embodiment of the present invention will now be described with reference to FIGS. 1, 2, 3, and 4. In FIG. 1, the switching circuit 200A is shown in the first state which is the fake side tone condition. Sound 2A enters the microphone on the handset of the toll telephone being operated by the user. The sound is converted to electrical impulses by the microphone and is carried to the electronic switching devices via a cable from said handset. While the switching circuit 200A is in the first state, the audio signal is routed back out to the speaker on the handset where it is then reproduced as a sound wave for the user to hear along with sound from the phone line. Being able to hear sounds such as blowing into the Mic returning to the ear piece, the user is reassured of the working status of the toll telephone. The user will then continue with his or her call, dialing the number, depositing the requested amount of change (if the call is a number that is to be charged to the user). The electronics within the toll telephone will then communicate with a central office that is associated with the line connected to the toll telephone, and will initiate the dialing out process. When the calling party is reached, a signal will be sent from a central office to the toll telephone to indicate that the call has been connected. This signal is detected by the electronic control circuitry and it will then charge the switching circuit 200B to a mode as shown in the bottom portion of FIG. 1 At this point, sounds 2B entering the mouthpiece of the handset will create electrical impulses that will now be routed not to the earpiece 1B, but through a hybrid 150 to a phone line which is connected to the other party by a central office 100. The telephone conversation can now be carried out, the toll telephone user can be heard. When the call is completed, the microprocessor will change the switching circuit back to the default mode shown as 200A before the next call is placed. The switching circuit is controlled by a digital logic command issued from the microprocessor U2 as depicted in FIG. 2. The microprocessor 2 is a crystal run processor which is connected to supporting circuitry via Data, Address, and control lines running to and from the processor. It receives its power from a five volt power rail witch also powers other devices within the toll telephone, such as the Operation EPROM2 U5 and Voice EPROM2 U3. The Operation data chip U5 holds the binary instructions that the microprocessor U2 executes while it is running. The microprocessor U2 also is able to scan and read the keypad to detect witch keys the user of the toll telephone is entering. Other inputs to U2 include coin sensors witch detect coins that are inserted and what their values are, On/Off hook censing, and programing switch status. Other microprocessor U2 lines are configured as outputs, to allow the it to control the other support circuits contained within the electronics of the toll telephone. One of these lines is used to tell the switching circuit of FIG. I which state to operate in. Based on the code contained in the Operation chip U5, the program running on the microprocessor U2 can determine when to change the output state (a logic high or logic low) of this line, designated as Mic Control within this illustration. A detailed schematic is of the switching circuit can be seen in FIG. 3. The Mic Input is the line coming in from the microphone contained in the mouthpiece of the handset of the toll telephone. The circuitry consisting of C26 Q15, Q16, Q17, R75, R66, CR16, CR25, and C44 are present to bias the Mic signal and to allow it to be at a compatible level with the other components. Two signals, which are labeled PA0 and PA1, are generated from the microprocessor to enable the Mic. The Mic Control line, as shown in FIG. 2 originating from the microprocessor, is used to enable or disable the digitally controlled analog switches U23A and U32C. The enable inputs to the 4066 analog switches used are pin 13 and pin 5 of U32A and U32C respectively. When the enable pin of this chip is set to a logic high state, the analog signal will be allowed to pass through the gate. Said control line is inverted by U7E insuring that while one gate is enabled, the other will be disabled. When said control line changes its state, the 4066 gate that was enabled will now be disabled, and the disabled gate becomes the enabled one. With this configuration, if Mic Control is in a logic high state, U32A will pass the audio signal from Mic Input to the Fake Mic Path to Audio Out. At the same time, U32C will be disabled, and will block said audio signal from reaching Mic d Output to the Central Office. When Mic Control is a logic low,the conditions will be reversed, and the path of the Mic Input will be to the Mic/Output to the Central Office and not to Fake Mic Path to Audio out, The circuitry used to blend together the different audio signals that can be heard by a user of the toll telephone is shown in FIG. 4. the Fake Mic Path from the switching circuit described above is connected to the positive input of the amp U14D. Audio signals from the Speech/Generator, if present, is also connected at this junction. Sound signals from an outside phone line connected to a central office is first gated using U13C. This allows the selective control of being able to hear the sound of an outside line or to mute the sound, under microprocessor control. The output of amp U14D passes through R64 to set the audio level and is then sent to the speaker in the handset to be heard. While the toll telephone is in the Fake Mic mode, the audio signal that has come from the microphone will pass through this circuit and will be heard on the handset.

1. A toll telephone using an electronic circuit capable of controlling the path of sound from the handset of said toll telephone comprised of: a microprocessor to make programed decisions on the timing of controlled switching actions; a microprocessor controlled analog switch to steer the audio signal back to the speaker in said handset before dialing; a microprocessor controlled analog switch to steer the audio signal out to a central office over a phone line; a logic inverter to insure only one of the two said paths is selected to be used at any given time.

2. The toll telephone using the electronic circuit recited in claim 1 to further use controlled switching of the path of sound to lessen fraudulent use of said toll telephone by muting sound to line while still allowing path of sound to earpiece.

3. The toll telephone using an electronic circuit recited in claim 1 to further use controlled switching of the path of sound to remove the path to the earpiece while being routed out to a phone line after a call is completed.
